(19) United States
(12) Patent Application Publication
(10) Pub. No.: US 2012/0142240 A1
(43) Pub. Date: Jun. 7, 2012

(54) POLYURETHANE COMPOSITE MATERIAL

(75) Inventors: Berend Eling, Lemforde (DE); Stefan Auffarth, Holdorf (DE); Shane Mc Donnell, Munchen (DE)

(73) Assignee: BASF SE, Ludwigshafen (DE)

(21) Appl. No.: 13/311,777

(22) Filed: Dec. 6, 2011

Related U.S. Application Data
(60) Provisional application No. 61/420,346, filed on Dec. 7, 2010.

(51) Int. Cl. B32B 5/02; E04B 1/78; E04B 1/84; B82Y 40/00; B82Y 30/00

(52) U.S. Cl. 442/59; 252/62; 977/773; 977/840

(57) ABSTRACT

The invention relates to an aerogel composite material, a process and a composition for producing the composite material, and also the use of the composite material.

This invention relates to a composite material comprising a binder and nanoporous particles, more particularly an aerogel or aerosil, a process and a composition for producing the composite material, and also the use of the composite material.

Aerogels are highly porous solid bodies in which the predominant portion of their volume consists of pores. Aerogels can be based for example on silicates, metal oxides, but also on plastics, carbon, or organic-inorganic hybrids. The diameter of aerogel pores is in the nanometer range. Owing to their high pore volume and narrow channel structures, aerogels are particularly useful as insulating materials combining outstanding thermal insulation properties with low density. Aerogels are initially present as particles, powders, granules or monoliths, and can be subjected with the use of binders to a shaping process to form panels by pressing for example.

The shaping process of the aerogel is concluded during the sol-gel transition. Once the solid gel structure has developed, the outer form can only be changed by comminution, for example grinding. Aerogel in the context of the present invention also comprehends xerogels and cryogels.

EP-A-0 340 707 discloses insulating materials from 0.1 to 0.4 g/cm³ in density with good thermal insulation capacity and sufficiently high compressive strength, which are obtained by adhering silica aerogel particles together using an organic or inorganic binder. Cement, gypsum, lime or waterglass are mentioned as examples of suitable inorganic binders.

EP 489 319 A2 discloses composite foams based on silica aerogel particles and a styrene polymer foam. U.S. Pat. No. 6,121,336 discloses improving the properties of polyurethane foams by incorporation of silica aerogels. DE 4441567 A1 discloses composite materials from aerogels and inorganic binders where the aerogel particles have corpuscle diameters of less than 0.5 mm. EP 672635 A1 discloses shaped articles from silica aerogels and binders that additionally utilize sheet-silicates or clay minerals. U.S. Pat. No. 6,143,400 discloses composite materials from aerogel particles and an adhesive that utilize aerogel particles having diameters less than 0.5 mm. DE 105 335 64 discloses composite materials comprising aerogel particles, binders and a fiber agent. WO 2007/011988 A2 discloses compositions with so-called hybrid aerogel particles and a binder wherein the aerogel particles may form covalent bonds with the binder.

EP 667370 A2 discloses a composite foam comprising 10% to 90% by volume of SiO₂ aerogel particles and 90% to 10% by volume of a preferably polyurethane and/or polyolefin foam. This foam is obtained by surrounding a bed of aerogel particles with the polymeric foam.

US 2009/0029147 A1 discloses an aerogel-polyurethane composite material obtained by first producing an open-cell polyurethane foam and adding an aerogel precursor based on hydrolyzed tetraethoxysilicate, water and ethanol to the polyurethane foam.

However, producing shaped articles of this type frequently necessitates the use of high binder contents. In addition, many performance characteristics such as, for example, thermal conductivity or breaking strength are still in need of improvement. There are frequently also issues with the production of shaped articles. Numerous organic binders cannot be used on account of their high viscosity. The use of low-viscosity dispersions frequently requires an excessive degree of dilution with aqueous solvents, which has the disadvantage that the binder in the dispersions does not enter any bond with the generally hydrophobic silica aerogel particles owing to the absence of aerogel surface wetting.

The problem addressed by this invention was therefore that of providing composite materials which can combine a relatively low binder content with an improved, reduced thermal conductivity and a low density. The composite materials shall also be obtainable in a simple manner, for example through improved utility of organic binders.

The problem addressed by this invention was more particularly to provide shaped articles that combine a low binder content with an improved, reduced thermal conductivity, mechanical stability and a low density.

The invention provides a composite material comprising a binder and nanoporous particles, more particularly an aerogel or aerosil, wherein the binder is the reaction product of a water-emulsifiable polyurethane-based prepolymer with an aqueous system, more particularly water. The aqueous system consists of water in a preferred embodiment. Further constituents can be present, more particularly
additions which do not react with isocyanates,
additions which do react with isocyanates, these additions being more particularly polyols and polyamines.

The invention further provides a process for producing a composite material, said process comprising mixing a prepolymer based on an isocyanate and an isocyanate-reactive compound P, the prepolymer having isocyanate groups, with nanoporous particles, more particularly an aerogel or aerosil, in the presence of added water, under conditions which ensure that the prepolymer will react with the added water.

In a preferred embodiment, the particles form a homogeneous distribution in the composite material.

The invention further provides a composition for producing a composite material which is in accordance with the present invention, the composition comprising nanoporous particles, more particularly aerogel or aerosil, a prepolymer comprising isocyanate groups and water, wherein these constituents can also be present in the spatially separated form of a kit.

In the context of the present invention, unless otherwise stated, the terms used are defined as follows and the parameters mentioned are measured as follows:
Particle: Particles are corpuscles which either are monolithic, i.e., consist of one piece, or alternatively comprise essentially particles having a diameter smaller than that of the corpuscle, which are optionally bonded together by a suitable binder or joined together by pressing to form larger corpuscles.
Porosity: Ratio of void volume to overall volume, as measured by nitrogen adsorption and desorption (<100 nm) and mercury porosimetry (>100 nm).
Hydrophobic: Hydrophobic substances in the context of the present substances are such substances as have a contact angle of more than 90° with water at room temperature.
Nanoporous: is to be understood as meaning that the pores in the particles have a size in the range from 0.1 to 500 nm, more particularly <200 nm and more preferably <100 nm (d50) and the porosity is from 50 to 99, more particularly from 70 to 99 and more preferably from 80 to 99.
Granular: is to be understood as meaning that the corpuscles are present in a size of 0.1 μm to 100 mm and preferably of 1 μm to 30 mm (d50) and the ratio of the longest axis to the shortest axis of the particles is preferably in the range from 4:1 to 1:1.
Pyrogenous silica: Pyrogenous silica preferably consists of microscopic droplets of amorphous silicon dioxide (silica) which have melted together to form branched, chainlike, three-dimensional secondary particles which agglomerate to form tertiary particles. The resulting powder has an extremely low bulk density and a high surface area. The primary particles have a size of 5-50 nm (d50). They are aporous and have a surface area of 50-600 m²/g and a density of 2.2 g/cm³. Pyrogenous silica is obtained by flame pyrolysis of silicon tetrachloride or from quartz sand vaporized in an electric arc at 3000° C.
Molecular weight: The reported molecular weights are based on the number average Mn, in g/mol, unless otherwise stated.
Prepolymer A polymer comprising isocyanate groups and obtainable by reacting an isocyanate with an isocyanate-reactive compound P, more particularly a compound having an acidic hydrogen atom and more preferably a polyol, wherein the isocyanate is used in excess, so that the prepolymer has free isocyanate groups.
d₅₀ value Size than which 50% of the particles are larger and 50% are smaller.
Aqueous alkali silicate The aqueous silicate of the present invention is preferably an alkali metal or ammonium silicate, more preferably ammonium, lithium, sodium or potassium waterglass, or combinations thereof with a (silica) modulus which is defined by the molar ratio of SiO₂ to M₂O of 4.0-0.2, preferably 4.0-1.0, where M is a monovalent cation. The aqueous silicate has a solids content of 10-70% by weight, preferably 30-55% by weight and/or a silicate content, reckoned as SiO₂, of 12-32% by weight and preferably 18-32% by weight. Sodium waterglass and potassium waterglass are particularly preferred. Waterglass viscosity should be in the range of 0.2-1.0 Pa*s. Higher viscosities should be lowered by adding a suitable aqueous alkali solution.

Preferred components to be used according to the present invention will now be recited, the combination of which shall be considered to form part of the present invention even if not specifically recited.

### Isocyanates

Useful organic isocyanates include commonly known aromatic, aliphatic, cycloaliphatic and/or araliphatic isocyanates, preferably diisocyanates, for example 2, 2′-, 2,4′- and/or 4,4′-diphenylmethane diisocyanate (MDI), polymeric MDI, 1,5-naphthylene diisocyanate (NDI), 2,4- and/or 2,6-tolylene diisocyanate (TDI), 3,3′-dimethylbiphenyl diisocyanate, 1,2-diphenylethane diisocyanate and/or phenylene diisocyanate, tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate (H12MDI), preferably 2,2′-, 2,4′- and/or 4,4′-diphenylmethane diisocyanate (MDI), polymeric MDI, 1,5-naphthylene diisocyanate (NDI), 2,4- and/or 2,6-tolylene diisocyanate (TDI), hexamethylene diisocyanate (HDI), 4,4′-, 2,4′- and 2,2′-dicyclohexylmethane diisocyanate (H12MDI) and/or IPDI, more particularly 4,4′-MDI and/or hexamethylene diisocyanate.

Particularly preferred isocyanates are diphenylmethane diisocyanates (MDI), more particularly polymeric MDI, more particularly with a viscosity of 10-10000 mPas, more particularly of 20-5000 mPas measured at 25° C. to DIN53018. Very particularly preferred types have a viscosity between 50 and 1000 mPas.

Particularly preferred isocyanates are HDI and IPDI, especially low-volatile derivatives of these isocyanates such as trimer, dimer, biuret and allophanate.

Isocyanate-reactive compounds

Useful isocyanate-reactive compounds (P) include commonly known isocyanate-reactive compounds, for example polyesterols, polyetherols, polyether amines and/or polycarbonate diols, which are typically also subsumed under the term “polyols”, with a number average molecular weight (Mn) of 106 to 12000 g/mol, preferably 100 to 10000 g/mol, more particularly 200 to 8000 g/mol and a hydroxyl value of 14 to 1839 mg KOH/g, more particularly of 28 to 600 mg KOH/g and a functionality of 2 to 8, preferably 2 to 3, more particularly 2.

A particularly preferred embodiment utilizes by way of isocyanate-reactive compounds (P) polyalkylene glycols, more particularly polytetrahydrofuran (PTHF), polybutylene glycols, polypropylene glycols, polyethylene glycols and copolymers obtained by addition reaction of ethylene oxide, butylene oxide and propylene oxide. The copolymers may have a block or mixed structure. Particularly preferred polypropylene glycols and polybutylene glycols have a molecular weight of 400 to 10000 g/mol more particularly of 600 to 8000 g/mol and preferably a functionality of 2 to 8 and more preferably 2 to 3.

Particularly preferred polyethylene glycols have a molecular weight of 61 to 8000 g/mol and more particularly of 200 to 6000 g/mol and preferably a functionality of 2 to 8 and more preferably 2 to 3.

A further embodiment of the invention utilizes water-emulsifiable prepolymers admixed with polymers comprising polyethylene oxide. The abovementioned polyethylene glycols can be used for this purpose. It is further also possible to use polyethylene oxide polymers of the following structure:

RO(CH₂—CH₂O)ₙH where
R is an alkyl free radical of more particularly 1 to 4 carbon atoms
n is a number from 3 to 50.

Typical examples of such components are methoxypolyethylene glycols with a molecular weight of 200 to 2000 g/mol and preferably of 300 to 1000 g/mol. Prepolymers with alkylpolyethylene glycol are known from GB 1528612.

In a further embodiment of the invention, the emulsifiability of isocyanate-based prepolymers is improved by modifying the prepolymers with ionizable groups such as aminosilanes, see WO 2010/112155 A2 and/or ionic groups such as carboxylates, phosphates and sulfates, see DE-A-2359606. This approach is particularly suitable when aqueous alkali silicates and/or colloidal silica sols are used.

The isocyanates reacted with the isocyanate-reactive compounds P to be used according to the present invention are water dispersible, particularly in the event of using polyethylene glycols having a molecular weight of 106 to 4000 g/mol and/or alkylpolyethylene glycols having a molecular weight of 200 to 2000 g/mol.

In a further embodiment of the invention, the emulsifiability of isocyanate-based prepolymers is achieved through the use of surfactants and/or other surface-active substances. Such surface-active substances include a broad pallet of wetting agents and surfactants and are effective in improving the dispersibility of polyurethane prepolymer in water, as described in Handbook of Industrial Surfactants, 4th Edition, pages 6279-6331. Emulsification auxiliaries include but are not limited to the following: polyalkoxylates, polyalkylene glycols, polyureas, polyglycosides and fatty alcohol esters.

Dispersions of prepolymer are preferably prepared using water since it dramatically reduces the viscosity of prepolymers, does not penetrate into the aerogel pores and reacts with isocyanate to form urea. Optionally, waterglass or (aqueous) silica sols can also be used instead of water. By using these dispersion media, the proportion of inorganic compounds in the composite material can be increased. Moreover, components can be added to the water that improve the wetting of aerogels. The penetration of water into the pores of the gel is generally not an issue, since aerogels have strongly water-rejecting properties. Components can be added to the water that improve the wetting of aerogels.

### Nanoporous Particles

Preferred nanoporous particles are granular. The nanoporous particles in further preferred embodiments are aerogels or aerosils which are preferably pyrogenous silica. These can be organic, inorganic or organic-inorganic.

### Aerogel

Suitable aerogels for the composite materials of the present invention are more particularly those based on oxides, more particularly silicon dioxide and metal oxides, more particularly alumina, titania and zirconia, or those based on organic substances, for example melamine-formaldehyde condensates (U.S. Pat. No. 5,086,085), resorcinol-formaldehyde condensates (U.S. Pat. No. 4,873,218) and also aerogels obtainable by polymerization of furfural with phenolic novolak resins. Of particular suitability are compounds which are suitable for sol-gel technology, see for example WO 97/10188 A1, page 7, first paragraph, for example silicon or aluminum compounds. However, they can also be based on mixtures of materials mentioned above. Preference is given to using aerogels comprising silicon compounds. Particular preference is given to aerogels comprising SiO₂ and more particularly SiO₂ aerogels, which are optionally organomodified.

Preferred aerogels have the following parameters:
Porosity: 50 to 99%, especially 70 to 99%, more preferably 80 to 99%
Density: from 30 to 300 g/L, preferably <150 g/L
Particle diameter: from 0.001 to 100 mm, preferably from 0.01 to 10 mm (d₅₀)
Pore diameter: 0.1 to 500 nm, especially <200 nm, more preferably <100 nm, especially 1 to 100, preferably 10 to 50 nm.

In addition, the thermal conductivity of aerogels decreases with increasing porosity and decreasing density, down to a density in the region of 0.1 g/cm³. The thermal conductivity of granular aerogel should preferably be less than 40 mW/m*K and more preferably less than 25 mW/m*K.

Particularly preferred aerogels are silica aerogels that consist essentially of amorphous silicon dioxide but, depending on their method of making, may further comprise organic compounds.

Silica aerogel particles are obtainable in the known manner from waterglass solution via the stages of silica hydrogel, solvent exchange and subsequent supercritical drying. The bead form generally present is the result of a fast-gelling silica sol being sprayed from a specially designed die and the drops gelling in flight. Further details on this are described in DE-A-2103243. The exchange of hydrogel water for other liquids that are chemically inert with regard to silicon dioxide is described for example in U.S. Pat. No. 2,093,454, U.S. Pat. No. 3,977,993 and JP-A-53/025295.

The aerogel particles can be used in monomodal, bimodal or multimodal distribution.

In a preferred embodiment, the aerogel particles have hydrophobic groups on the surface. Suitable groups for durable hydrophobicization are for example trisubstituted silyl groups of general formula —Si(R)₃, preferably trialkyl- and/or triarylsilyl groups, where each R is independently a nonreactive organic moiety such as C₁-C₁₈ alkyl or C₆-C₁₄ aryl, preferably C₁-C₆ alkyl or phenyl, more particularly methyl, ethyl, cyclohexyl or phenyl, which moiety may be additionally substituted with functional groups. The use of trimethylsilyl groups is particularly advantageous for durably hydrophobicizing the aerogel. Introducing these groups can be accomplished by gas phase reaction between the aerogel and, for example, an activated trialkylsilane derivative, e.g., a chlorotrialkylsilane or a hexaalkyldisilazane.

### Functionalizing the Nanoporous Particles

The nanoporous particles, more particularly aerogels, can be fixed in the foam. Fixing the nanoporous particles in melamine resin foam can be augmented by introduction of reactive groups into the nanostructure or by incorporating small amounts of binders.

Functionalized chemical compounds such as alkoxysilanes, e.g., 3-aminopropyltri-ethoxysilane or 3-aminopropyltrimethoxysilane, are useful for chemically functionalizing the nanostructure for example. These reactive groups are bonded to the aerogel in the first step via the silane unit and in the 2nd step the amino group allows chemical attachment to the reactive groups remaining on the surface of the melamine resin foam.

Suitable systems for functionalization are described at very great length in WO 2005103107 A1, page 9, line 18 to page 15, line 4, and are expressly incorporated in this application by reference.

Useful binders include polymeric substances for example melamine-formaldehyde resins. Suitable polyurethane resins, polyester resins or epoxy resins are known to a person skilled in the art. Such resins are found for example in Encyclopedia of Polymer Science and Technology (Wiley) under the following chapters: a) Polyesters, unsaturated: Edition 3, Vol. 11, 2004, p. 41-64; b) Polyurethanes: Edition 3, Vol. 4. 2003, p. 26-72 and c) Epoxy resins: Edition 3, Vol. 9, 2004, p. 678-804. In addition, Ullmann's Encyclopedia of Industrial Chemistry (Wiley) includes the following chapters: a) Polyester resins, unsaturated: Edition 6, Vol. 28, 2003, p. 65-74; b) Polyurethanes: Edition 6, Vol. 28, 2003, p. 667-722 and c) Epoxy resins: Edition 6, Vol. 12, 2003, p. 285-303. It is further possible to use amino- or hydroxyl-functionalized polymers, more particularly a polyvinylamine or polyvinyl alcohol. Examples based on melamine and phenolic resin and also acrylamide are described in EP 045153581 and DE 19649796A1.

The nanoporous particles can be impregnated with the adhesive-bonding assistants before the impregnating step or directly in the foam structure.

The aerogel particles can be used in monomodal, bimodal or multimodal distribution. The process of producing the material generates corpuscles having different sizes. Particle diameter can vary from 0.1 μm up to 100 mm. The corpuscles can be size classified by sieving with different pore sizes. The corpuscles can be separated into so-called sieve fractions. Particular preference is given to corpuscles having a diameter up to 10 mm.

A particularly preferred aerogel is the SiO₂-based Aerogel® TLD 302 marketed by Cabot Cooperation (Boston, USA) with the following properties according to producer data:

Thermal conductivity: 9 to 20 mW/m*K

### Porosity: >90%

Bulk density: 65-85 kg/m³
Particle density: 120-180 kg/m³
Pore diameter: 10 to 40 nm
Surface area: ca. 600-800 m²/g
Particle diameter: 7 μm to 4 mm (d₅₀)
Surface property: hydrophobic
Opacity: translucent

In a particularly preferred composite material the prepolymer is obtainable by reacting a) an isocyanate, preferably a diisocyanate, with b) at least a polyol, optionally c) in the presence of an emulsifying auxiliary or of a surfactant.

In a particularly preferred embodiment the prepolymer is obtainable by reaction of in each case at least

a) an isocyanate, in particular diisocyanate, in particular with
b1) a polyol B1 whereby the prepolymer is water emulsifiable without surfactant or emulsification auxiliary, or
b2) with a polyol B2 whereby the prepolymer is not water emulsifiable without surfactant or emulsification auxiliary, in which case the prepolymer is emulsified with a surfactant or emulsification auxiliary, or
b3) with a mixture of a polyol B1 and B2, preferably in a weight ratio ranging from 5:95 to 95:5, more particularly with an amount of B1 whereby the prepolymer is emulsifiable in water.

In a preferred embodiment the polyol B1 is a polyethylene glycol, in particular having a molecular weight of 200 to 6000 g/mol and/or an alkylpolyethylene glycol having a molecular weight of 200 to 2000 g/mol.

In a further, particularly preferred embodiment the polyol B2 is a polypropylene glycol, an addition product of an alkylene oxide, more particularly propylene oxide onto a polyhydric alcohol, more particularly 1,2-propanediol and glycerol, an addition product of an alkylene oxide and more particularly propylene oxide onto at least a starter molecule with a functionality Fn from 2 to 8, or a hydroxyl group-containing glyceride of a fatty acid, or a composition comprising essentially such a glyceride, like castor oil in particular.

A preferred embodiment utilizes the following substances as emulsifying auxiliaries and surfactants: polyglycosides, fatty alcohol esters, polysiloxanes, more particularly polysiloxanes modified with polyether groups, and also silicone-free surfactants and/or addition agents comprising ionic groups such as carboxylates, phosphates and sulfates. By way of example there may be mentioned here the surfactants marketed by BASF S.E. (Ludwigshafen, Germany) under the trade names of Lutensol®, Plurafac®, Pluronic®, Emulan®, Emulphor® and Lutensit®.

### Additional Reactive Components

In one embodiment of the invention, conventional chain-extending agents and/or crosslinkers can be used in the reaction of isocyanate groups with isocyanate-reactive groups. Useful chain-extending agents include for example diols, preferably with a molecular weight of 60 to 490 g/mol, more particularly butanediol. In a preferred embodiment, the isocyanate is reacted with the isocyanate-reactive compound in the presence of an acid or of an acid-detaching compound, more particularly diglycol bischloroformate (DIBIS). Furthermore, the reaction may be catalyzed using catalysts known per se, but which are generally not needed with aromatic isocyanates. One embodiment utilizes waterglass and/or a silica sol. Waterglass has a catalytic effect because of its basic properties.

### Additives

The composite may comprise effective amounts of further addition agents such as, for example, dyes, pigments, fillers, flame retardants, synergists for flame retardants, antistats, stabilizers, plasticizers, blowing agents, surfactants (e.g., silicones) and IR opacifiers.

To reduce the radiative contribution to thermal conductivity, the composite material may comprise IR opacifiers such as, for example, carbon black, expandable graphite, titanium dioxide, iron oxides or zirconium dioxide and also mixtures thereof, which is advantageous for uses at high temperatures in particular.

With regard to cracking and breaking strength, it can further be advantageous for the composite material to comprise fibers. As fiber material there may be used organic fibers such as, for example, cellulose, cellulose esters, polyacrylonitriles and copolymers thereof, and also polyacrylonitrile, polypropylene, polyester, nylon or melamine-formaldehyde fibers and/or inorganic fibers, for example glass, mineral and also SiC fibers and/or carbon fibers.

The fire class of the composite material obtained after drying is determined by the fire class of the aerogel and of the inorganic binder and also, as the case may be, the fire class of the optional fiber material. To achieve a very favorable fire class for the composite material (low-flammable or incombustible), the fibers should consist of noncombustible material, e.g., mineral, glass or SiC fibers.

In order to avoid increased thermal conductivity due to added fibers
a) the volume fraction of fibers should be 0.1 to 30% and preferably 1 to 10%, and
b) the thermal conductivity of fiber material should preferably be <1 W/m*K.

A suitable choice of fiber diameter and/or material reduces the radiative contribution to thermal conductivity and increases mechanical strength. For this, fiber diameter should preferably be in the range from 0.1 to 30 μm.

The radiative contribution to thermal conductivity can be particularly reduced when using carbon fibers or carbon-containing fibers.

Mechanical strength can further be influenced by fiber length and distribution in the composite material. Preference is given to using fibers between 0.5 and 10 cm in length. Fabrics woven from fibers can also be used for plate-shaped articles.

The composite may further comprise addition agents used in its method of making and/or formed in its method of making, for example slip agents for compression molding, such as zinc stearate, or the reaction products of acidic or acid-detaching cure accelerants in the event of using resins.

The fire class of the composite material is determined by the fire class of the aerogel, of the fibers and of the binder and also of further substances optionally present. To achieve a very favorable fire class for the composite material, it is preferable to use nonflammable types of fibers, for example glass or mineral fibers, or low-flammable types of fibers such as, for example, TREVIRA C® or melamine resin fibers, aerogels based on inorganics and more preferably based on SiO₂, and low-flammable binders such as, for example, inorganic binders or urea- or melamine-formaldehyde resins, silicone resin adhesives, polyimide resins and polybenzimidazole resins.

The composite material may further comprise flame retardants as an addition agent, for example ammonium polyphosphate (APP), aluminum trihydroxide or other suitable flame retardants known to a person skilled in the art.

### Processing

When the material is used in the form of sheet bodies, for example plates or mats, it may have been laminated on at least one side with at least one covering layer in order that the properties of the surface may be improved, for example to increase the robustness, turn it into a vapor barrier or guard it against easy soiling. The covering layers can also improve the mechanical stability of the composite molding. Coating with covering layers can also more particularly prevent the plates or mats obtained being dusty, which might have an adverse effect on adherence in exterior elements for example. When covering layers are used on both faces, these covering layers can be identical or different.

Useful covering layers include any materials known to a person skilled in the art. They can be aporous and hence act as vapor barrier, for example polymeric foils, preferably metal foils or metalized polymeric foils that reflect thermal radiation. But it is also possible to use porous covering layers which allow air to penetrate into the material and hence lead to superior acoustical insulation, examples being porous foils, papers, wovens or nonwovens.

The surface of the composite material can also be coated with a material to reduce the flammability, for example with an intumescent layer.

An applied layer can further improve the adherence to other substrates such as concrete for example. Moisture absorption can be reduced by applying a suitable layer. Such a layer can also consist of a reactive system such as, for example, epoxy resins or polyurethanes, which can optionally be applied by spraying, blade coating, casting or brushing or the like.

The covering layers may themselves also consist of two or more layers. The covering layers can be secured with the binder with which the fibers and the aerogel particles are bonded to and between each other, but it is also possible to use some other adhesive.

The surface of the composite material can be closed and consolidated by incorporating at least one suitable material into a surface layer. Useful materials include, for example, thermoplastic polymers, e.g., polyethylene or polypropylene, or resins such as melamine-formaldehyde resins for example.

The composite materials of the present invention have thermal conductivities between 10 and 100 mW/m*K, preferably in the range from 10 to 50 mW/m*K and more preferably in the range from 13 to 30 mW/m*K.

### Use

The composite materials of the present invention have outstanding mechanical properties (enhanced breaking strength for example) and thermal insulation properties (thermal conductivities of less than 0.025 W/m*K can be achieved in general) and so can be used in a wide variety of fields.

Examples thereof are the thermal insulation of buildings, fuel boilers, cooling appliances, baking ovens (cf. EP-A-0 475 285), heating pipes, district heating lines, liquid gas containers, night storage ovens and also vacuum insulation in technical appliances of various kinds.

More particularly, the composite materials of the present invention are useful for internal insulation to achieve a low-energy standard, for external insulation, optionally combined with cementitious and inorganic adhesives, and also as part of a combination of base render, reinforcing mortar and top render, for roof insulation, and also in technical applications in refrigerators, transportation boxes, sandwich elements, pipe insulation and technical foams.

### EXAMPLES

The following components were used in the inventive and comparative examples:

TABLE 1

| Short name | Composition |
|---|---|
| Isocyanate 1 | Lupranat ® M 50 from BASF SE, Ludwigshafen, Germany, polymer MDI |
| | of comparatively high functionality and 500 cP viscosity, NCO = 31.5% |
| Isocyanate 2 | Lupranat ® M 200 R from BASF SE, Ludwigshafen, Germany, polymer |
| | MDI of comparatively high functionality and 2000 cP viscosity, NCO = |
| | 31.0% |
| Isocyanate 3 | Lupranat ® M 20 from BASF SE, Ludwigshafen, Germany, solvent-free |
| | product based on 4,4′-diphenylmethane diisocyanate (MDI) with |
| | comparatively high-functional oligomers and isomers, NCO = 31.5% |
| Isocyanate 4 | Basonat ® LR 9056 from BASF SE, Ludwigshafen, Germany, water- |
| | emulsifiable polyfunctional isocyanate based on HDI, for crosslinking of |
| | polymer dispersions, NCO = 18% |
| Isocyanate 5 | Lupranat ® MI from BASF SE, Ludwigshafen, Germany, mixture of 2,4′- |
| | and 4,4′-diphenylmethane diisocyanate (MDI), NCO = 33.5% |
| Polyol 1 | Polypropylene glycol with Mw = 2000 g/mol |
| Polyol 2 | Pluriol ® A500E from BASF SE, Ludwigshafen, Germany, |
| | methylpolyethylene glycol, Mw = 500 g/mol |
| Polyol 3 | Polyethylene glycol with Mw = 600 g/mol |
| Polyol 4 | Polyol obtained by addition of propylene oxide onto glycerol with Mw = |
| | 420 g/mol |
| Polyol 5 | Polyol obtained by addition of propylene oxide onto glycerol with |
| | ethylene oxide cap, hydroxyl number 35 mg KOH/g |
| Polyol 6 | Polyol obtained by addition of propylene oxide onto a mixture of |
| | sucrose, pentaerythritol and diethylene glycol, hydroxyl number 405 mg |
| | KOH/g, functionality 3.9 |
| Polyol 7 | Polypropylene glycol with Mw = 1000 g/mol |
| Polyol 8 | Polyoxypropylene triol with Mw = 1000 g/mol |
| Polyol 9 | Recaptur castor oil from VWR International, hydroxyl number 179 mg |
| | KOH/g |
| Stabilizer 1 | Silbyk ® 9204 from BYK-Chemie GmbH, Wesel, Germany, polyether- |
| | modified polysiloxane |
| Stabilizer 2 | 1 mol of nonylphenol with 9 mol of ethylene oxide |
| Stabilizer 3 | Dabco ® DC 193 polysiloxane silicone from Air Products GmbH, |
| | Hattingen, Germany |
| Stabilizer 4 | Tegostab ® B 8404 polyether-modified polysiloxane from Evonik |
| | Goldschmidt GmbH, Essen, Germany |
| Stabilizer 5 | Dabco ® LK443E silicone-free surfactant from Air Products GmbH, |
| | Hattingen, Germany |
| Catalyst 1 | Jeffcat ® ZR 70 from Huntsman Polyurethanes, Everberg, Belgium, |
| | 2-(2-dimethylaminoethoxy)ethanol |
| Catalyst 2 | Dabco ® 33 LV diazabicyclooctane 33% in dipropylene glycol from Air |
| | Products GmbH, Hattingen, Germany |
| Catalyst 3 | Dabco ® DMEA dimethylethanolamine from Air Products GmbH, |
| | Hattingen, Germany |
| Catalyst 4 | Dabco ® BL 11 bis(dimethylaminoethyl) ether 70% in dipropylene glycol |
| | from Air Products GmbH, Hattingen, Germany |
| Catalyst 5 | N,N-Dimethylcyclohexylamine from BASF SE, Ludwigshafen, Germany |
| Catalyst 6 | Lupragen ® N600 N,N′,N″-trisdimethylaminopropylhexahydrotriazine |
| | from BASF SE, Ludwigshafen, Germany |
| Waterglass | Na waterglass of modulus 2.6-3.2, solids content 43.5% from van |
| | Baerle AG, Münchenstein, Switzerland |
| Aerogel | Cabot Nanogel ® TLD 302 amorphous silica from 1.2 to 4 mm in particle |
| | diameter, about 20 mm in pore diameter and >90 in porosity |

### Inventive Example 1

In a 1 L glass flask equipped with a stirrer and under constant agitation, 289.5 g of isocyanate 1 were heated to 60° C. and admixed with 0.05 g of diglycol bischloroformate (DIBIS). Thereafter, a mixture of 195.5 g of polyol 1 and 15 g of polyol 2 was gradually added. The temperature was kept constant at 80° C. for 4 h. This gave 500 g of a clear prepolymer having an NCO content of 16%. 160 g of the isocyanate prepolymer were mixed with 160 g of water to form a thin, milky, homogeneous emulsion. This emulsion was mixed with 80 g of aerogel by stirring with a blade stirrer. The mass thus obtained was introduced into a metal mold heated to 50° C. and lined with a thin film of polyethylene. The mold measures 20 cm×20 cm×20 cm and has a movable lid with which it can be closed. On closing the lid, excess emulsion was squeezed out. After one hour, the composite material was demolded and stored overnight in a heating cabinet at 60° C. The plate was subsequently dried at 80° C. to constant mass. The plate was subjected to physical measurements, the results of which are summarized in table 2.

### Inventive Example 2

In a 1 L glass flask equipped with a stirrer and under constant agitation, 289.5 g of isocyanate 2 were heated to 60° C. and admixed with 0.05 g of diglycol bischloroformate (DIBIS). Thereafter, a mixture of 195.5 g of polyol 1 and 15 g of polyol 2 was gradually added. The temperature was kept constant at 80° C. for 4 h. This gave 500 g of a slightly cloudy prepolymer having an NCO content of 16%. 96 g of the isocyanate prepolymer were mixed with 224 g of water to form a milky, homogeneous emulsion. This emulsion was mixed with 80 g of aerogel by stirring with a blade stirrer. The mass thus obtained was introduced into a metal mold heated to 50° C. and lined with a thin film of polyethylene. The mold measures 20 cm×20 cm×20 cm and has a movable lid with which it can be closed. On closing the lid, excess emulsion was squeezed out. After one hour, the composite material was demolded and stored overnight in a heating cabinet at 60° C. The plate was subsequently dried at 80° C. to constant mass. The plate was subjected to physical measurements, the results of which are summarized in table 2.

### Inventive Example 3

In a 1 L glass flask equipped with a stirrer and under constant agitation, 293.8 g of isocyanate 2 were heated to 60° C. and admixed with 0.05 g of diglycol bischloroformate (DIBIS). Thereafter, a mixture of 156.2 g of polyol 1 and 50 g of polyol 2 was gradually added. The temperature was kept constant at 80° C. for 4 h. This gave 500 g of a clear prepolymer having an NCO content of 16%. 22 g of the isocyanate prepolymer were mixed with 22 g of water to form a milky, homogeneous emulsion. This emulsion was mixed with 88 g of aerogel by stirring with a blade stirrer. The mass thus obtained was introduced into a metal mold heated to 60° C. and lined with a thin film of polyethylene. The mold measures 20 cm×20 cm×20 cm and has a removable lid with which it can be closed. After one hour, the composite material was demolded and stored overnight in a heating cabinet at 60° C. The plate was subsequently dried at 80° C. to constant mass. The plate was subjected to physical measurements, the results of which are summarized in table 2.

### Inventive Example 4

In a 1 L glass flask equipped with a stirrer and under constant agitation, 293.8 g of isocyanate 2 were heated to 60° C. and admixed with 0.05 g of diglycol bischloroformate (DIBIS). Thereafter, a mixture of 156.2 g of polyol 1 and 50 g of polyol 2 was gradually added. The temperature was kept constant at 80° C. for 4 h. This gave 500 g of a clear prepolymer having an NCO content of 16%. 25 g of the isocyanate prepolymer were mixed with 75 g of water to form a milky, homogeneous emulsion. This emulsion was mixed with 100 g of aerogel by stirring with a blade stirrer. The mass thus obtained was introduced into a metal mold heated to 60° C. and lined with a thin film of polyethylene. The mold measures 20 cm×20 cm×20 cm and has a removable lid with which it can be closed. After one hour, the composite material was demolded and stored overnight in a heating cabinet at 60° C. The plate was subsequently dried at 80° C. to constant mass. The plate was subjected to physical measurements, the results of which are summarized in table 2.

### Inventive Example 5

In a 3 L glass flask equipped with a stirrer and under constant agitation, 1520 g of isocyanate 2 were heated to 60° C. and admixed with 0.1 g of diglycol bischloroformate (DIBIS). Thereafter, a mixture of 433 g of polyol 3 and 47 g of polyol 2 was gradually added. The prepolymer had an NCO content of 20.2% and a viscosity of 9370 mPas at 23° C. 96.3 g of the prepolymer thus obtained were stirred with 4.8 g of stabilizer 1 at 900 rpm for 20 s. 300 g of water were added followed by renewed stirring at 900 rpm for 20 s. 150 g of aerogel were added and mixed in for 2 min with a spatula. The mass was pressed into a mold and the mold was closed and stored at 50° C. for 70 min. The plate formed from the composite material was demolded and dried at 50° C. for 15 h. The plate was subjected to physical measurements, the results of which are summarized in table 2.

### Inventive Example 6

A prepolymer having an NCO content of 13.9% was obtained by the reaction of 226 g of isocyanate 4 with 24 g of polyol 3 in the presence of 45 mg of dibutyltin dilaurate. 24.6 g of the prepolymer thus obtained was stirred with 1.4 g of stabilizer 1 at 900 rpm for 20 s. 78.5 g of water were mixed with 3.5 g of waterglass and 30 mg of catalyst 1 and stirred at 900 rpm for 5 min. The two components thus obtained were mixed with each other at 900 rpm for 30 s. 82 g of aerogel were added and mixed in with a spatula. The mass was mixed for 30 s with a Braun Multimix M 830 Trio manual stirrer at about 630 rpm and then lightly pressed into a mold (23 cm×23 cm) open at the top, and dried at 50° C. for 16 h. The plate was subjected to physical measurements, the results of which are summarized in table 2.

### Inventive Example 7

In a 1 L glass flask equipped with a stirrer, 934.5 g of isocyanate 1 were heated to 60° C. under constant agitation. Thereafter, 65.5 g of polyol 8 were gradually added. The prepolymer has an NCO content of 28% and a viscosity of 670 mPas at 25° C.

79.84 g of the prepolymer thus obtained were stirred with 7.97 g of stabilizer 1, 149.56 g of waterglass and 206.52 g of water for 20 s with a Braun Multimix M 830 Trio manual stirrer at about 900 rpm.

133.79 g of aerogel were added followed by stirring with a Braun Multimix M 830 Trio manual stirrer at about 650 rpm for 1 min. The mass was pressed into a mold and the mold was closed and stored at 50° C. for 70 min. The plate formed from the composite material was demolded and dried at 50° C. for 24 h. The plate was subjected to physical measurements, the results of which are summarized in table 2.

### Inventive Example 8

A prepolymer having an NCO content of 23% was obtained by the reaction of 820 g of isocyanate 1 with 180 g of polyol 9.

148.5 g of the prepolymer thus obtained were stirred with 14.86 g of stabilizer 5 and 488.38 g of waterglass 1 for 20 s with a Braun Multimix M 830 Trio manual stirrer at about 900 rpm.

248.82 g of aerogel were added followed by stirring with a Braun Multimix M 830 Trio manual stirrer at about 650 rpm for 1 min. The mass was pressed into a mold and the mold was closed and stored at 50° C. for 70 min. The plate formed from the composite material was demolded and dried at 80° C. for 24 h. The plate was subjected to physical measurements, the results of which are summarized in table 2.

TABLE 2
The aerogel mass fraction was computed as quotient of the mass of aerogel weighed
into the mold and the overall mass of dry composite material.

| | Unit | IE1 | IE2 | IE3 | IE4 | IE5 | IE6 | IE7 | IE8 |
|---|---|---|---|---|---|---|---|---|---|
| Aerogel mass | % | 54.0 | 51.0 | 82.0 | 82.0 | n.m. | 72.0 | 52.0 | n.m. |
| fraction | | | | | | | | | |
| Core density | kg/m³ | 186.7 | 208.7 | 131.6 | 149.5 | 132.0 | 116.0 | 200.3 | 180.0 |
| Compressive | N/mm² | 0.145 | 0.278 | n.m. | n.m. | n.m. | n.m. | n.m. | n.m. |
| strength/stress | | | | | | | | | |
| at 10% | | | | | | | | | |
| compression | | | | | | | | | |
| E modulus | N/mm² | 2.41 | 5.14 | n.m. | n.m. | n.m. | n.m. | n.m. | n.m. |
| Flexural | N/mm² | 0.11 | 0.27 | n.m. | n.m. | n.m. | n.m. | n.m. | n.m. |
| strength/stress | | | | | | | | | |
| Sag | mm | 1.6 | 1.9 | n.m. | n.m. | n.m. | n.m. | n.m. | n.m. |
| Thermal | mW/m * K | 28.9 | 24.3 | 19.3 | 20.1 | 21.6 | 20.6 | 27.8 | 25.3 |
| conductivity | | | | | | | | | |

n.m. denotes not measured

### III. COMPARATIVE EXAMPLES

### Comparative Example 1

Aerogel was admixed with various organic solvents (methanol, ethanol, 2-propanol, acetone and hexane). The particles were always observed to fill up with the particular solvent. The same thing was observed on adding polyols based on different starter molecules and different ratios of propylene oxide and ethylene oxide. Only water is not capable of penetrating into the particles owing to their strong hydrophobicity.

### Comparative Example 2

148.4 g of polyol 4 were mixed with 0.4 g of catalyst 2 and then stirred with a mixture of 83.5 g of isocyanate 5 and 55.7 g of isocyanate 3 in a Speedmixer® at 2000 rpm for 1 min. This reactive system was spatula mixed with 40 g of aerogel and pressed into a mold measuring 20 cm×20 cm×1 cm and heated to 45° C. After 30 min the still soft plate was demolded and cured at room temperature overnight. This gave a very hard material wherein the nanogel particles were filled with polyurethane, so that the material obtained was almost compact and had a density approaching 1000 g/L and a thermal conductivity too large for determination by the usual method for foamed materials, but in any rate above 80 mW/m*K.

### Comparative Example 3

An attempt was made to produce a composite material from aerogel and a typical polyurethane rigid foam reactive system according to the hereinbelow indicated variants a)-c) wherein the polyurethane reactive system had the following composition (in parts by weight):

Component A: polyol 6: 61.4
polyol 7: 31.7
stabilizer 4: 2.01
water: 4.77
catalyst 4: 0.03
catalyst 5: 0.10
catalyst 6: 0.05
   Component B: 100% of isocyanate 3
   Mixing ratio: 100 parts by weight of A to 162 parts by weight of B

| Variant | Process |
|---|---|
| a) | A mold was filled with aerogel and then with the above |
| | liquid polyurethane reactive system. |
| b) | The aerogel was introduced into a mold in which the above |
| | liquid polyurethane reactive system was just in the process |
| | of foaming up. |
| c) | Aerogel was mixed with the above liquid polyurethane reactive |
| | system and this mixture was then introduced into a closed mold. |

All variants a) to c) gave scarcely foam-wetted, completely unadhered nanogel particles which were compressed but not penetrated or even adhered by the foaming-up polyurethane. A useful composite material was thus not obtained in any of these cases.

### Comparative Example 3d)

A mixture of 10.4 g of polyol 5, 3.2 g of polyol 6, 2.4 g of stabilizer 2, 3.2 g of water, 0.16 g of stabilizer 3, 0.32 g of catalyst 3 and 0.046 g of catalyst 4 were mixed with 19.2 g of isocyanate 3 and placed in a mold which measured 20 cm×20 cm×4 cm and was filled to the top with 128 g of aerogel. After 10 min, a thin layer of polyurethane foam of very high density was obtained lying loosely on the nanogel since the foam was incapable of penetrating the latter. Only very few particles adhered weakly to the polyurethane.

The comparative examples show that the adherence of polyurethane foam to aerogel is too low to obtain a composite material. When, by contrast, liquid organic reaction components are brought into contact with the nanogel, the particles fill up therewith, which means that the special properties of the nanogel with regard to density and thermal conductivity are lost.

Surprisingly, the use of emulsions of prepolymers in water prevents the penetration of polyurethane components into nanogel particles.

We claim:

1. A composite material comprising a binder and nanoporous particles, more particularly an aerogel or aerosil, wherein the binder is the reaction product of a water-emulsifiable polyurethane-based prepolymer having free isocyanate groups with an aqueous system, more particularly water.

2. The composite material according to claim 1 wherein the prepolymer is obtainable by reacting a) an isocyanate, preferably a diisocyanate, with b) at least a polyol, optionally c) in the presence of an emulsification auxiliary or of a surfactant.

3. The composite material according to claim 2 wherein the prepolymer is obtainable by reaction of in each case at least
a) an isocyanate with
b1) a polyol B1 whereby the prepolymer is water emulsifiable without emulsification auxiliary, or
b2) with a polyol B2 whereby the prepolymer is not water emulsifiable without surfactant or emulsification auxiliary, in which case the prepolymer is emulsified with a surfactant or emulsification auxiliary, or
b3) with a mixture of a polyol B1 and B2, preferably in a weight ratio ranging from 5:95 to 95:5, more particularly with an amount of B1 whereby the prepolymer is emulsifiable in water.

4. The composite material according to claim 1 wherein the polyol is a polyethylene glycol having a molecular weight (Mn) of 200 to 6000 g/mol and/or an alkylpolyethylene glycol having a molecular weight of 200 to 2000.

5. The composite material according to claim 1 wherein the polyol is a polypropylene glycol or polybutylene glycol, an addition product of an alkylene oxide and more particularly propylene oxide or butylene oxide onto a polyhydric alcohol, an addition product of an alkylene oxide and more particularly propylene oxide onto a starter molecule of Fn 2-8, or a hydroxyl-containing glyceride of a fatty acid.

6. The composite material according to claim 2 wherein the surfactant or emulsification auxiliary used are a polyether-modified siloxane or a silicone-free surfactant.

7. The composite material according to claim 1 wherein the isocyanate is an aromatic isocyanate, more particularly MDI or a polymeric MDI.

8. The composite material according to claim 1 wherein the isocyanate is an aliphatic isocyanate, more particular HDI or a polymeric HDI.

9. The composite material according to claim 1 wherein the isocyanate-reactive compound used is a mixture of at least a polyalkylene glycol and an alkoxylated polyalkylene glycol.

10. The composite material according to claim 1 wherein the particles are optionally organomodified SiO₂ aerogels.

11. The composite material according to claim 10 wherein the modified aerogel is hydrophobic.

12. The composite material according to claim 1 wherein the composite material is present in the form of a coated plate or of a coated fibrous nonwoven web, and/or wherein the composite material has a thermal conductivity of 13 to 30 mW/mK and/or wherein the surface of the composite material is coated with a coating, and/or wherein the surface of the composite material is laminated.

13. A composition for producing a composite material according to claim 1, comprising nanoporous particles, more particularly an aerogel or aerosil, a prepolymer comprising isocyanate groups and waterglass.

14. A process for producing a composite material according to claim 1 which comprises mixing a prepolymer having isocyanate groups with nanoporous particles, more particularly an aerogel or aerosil, in the presence of added water to react the prepolymer with the added water.

15. The method of using a composite material according to claim 1 for thermal or acoustical insulation.
